(19) United States
(12) Patent Application Publication
(10) Pub. No.: US 2015/0263768 A1
(43) Pub. Date: Sep. 17, 2015

(54) TRANSMITTER

(71) Applicant: NEC CORPORATION, Tokyo (JP)

(72) Inventors: Shinichi Hori, Tokyo (JP); Kazuaki Kunihiro, Tokyo (JP); Kazumi Shiikuma, Tokyo (JP)

(73) Assignee: NEC CORPORATION, Tokyo (JP)

(21) Appl. No.: 14/428,106

(22) PCT Filed: Sep. 17, 2013
(86) PCT No.: PCT/JP2013/074994

§ 371 Date: Mar. 13, 2015

(30) Foreign Application Priority Data
Sep. 14, 2012 (JP) 2012-202592

(51) Int. Cl. H04B 1/04

(52) U.S. Cl. CPC H04B 1/04; H04B 2001/0408

(57) ABSTRACT

A transmitter includes: multiple digital transmitters which perform delta-sigma modulation on the same baseband signal; a combiner that combines the output signals from the plural digital transmitters and outputs the combined result; a control unit that generates an external signal different for every digital transmitter, to be supplied to each of the digital transmitters; and, an input means that supplies the different external signal for every digital transmitter, to the input terminal or the internal node of a delta-sigma modulator that performs the delta-sigma modulation, the delta-sigma modulator being provided for every digital transmitter.

### TECHNICAL FIELD

The present invention relates to a transmitter for use in communication and broadcasting equipment such as mobile phone systems, radio LAN (Local Area Network) equipment and others.

### BACKGROUND ART

Requirements for transmitters used in communication and broadcasting equipment, such as mobile phone systems, radio LAN equipment and others include low power consumption while ensuring that the waveform is maintained at a high accuracy regardless of the transmission power level. In particular, the requirement is that amplifiers transmit power with high efficiency because transmission power amplifiers that are placed at the final stage of the transmitter consume a large amount of power.

Recently, switching amplifiers have attracted attention as power amplifiers that are expected provide high power efficiency. A switching amplifier is assumed to receive pulse waveform signals as its input signals, and amplifies the power of the signal while maintaining the pulse waveform. The pulse waveform that is signal amplified by the switching amplifier is processed through a filter element so that frequency components other than the desired radio signal band are received, then are radiated from an antenna.

FIG. 1 is a circuit diagram showing a configurational example of a power amplifier called a class-D or class-S amplifier (which will be referred to hereinbelow as class-D amplifier as a representative) as a typical example of the switching amplifier. FIG. 1 shows a configurational example of a class-D amplifier that amplifies binary signals taking two levels, i.e., logic ‘1’ or ‘0’ (which will be referred to hereinbelow as a binary class-D amplifier).

The binary class-D amplifier shown in FIG. 1 is composed of switching elements inserted between a power supply and an output terminal and between the output terminal and the ground potential. The two switching elements are supplied with complementary pulse signals as open/close control signals so that only one of the switching elements will be turned on. From the class-D amplifier shown in FIG. 1, the same voltage as that of the power supply (high level: logic ‘1’) is output when the switching element on the power supply side is ON and the switching element on the ground potential side is OFF, whereas the ground potential (low level: logic ‘0’) is output when the switching element on the power supply side is OFF and the switching element on the ground potential side is ON.

Since the class-D amplifier shown in FIG. 1 needs no bias current, the ideal situation is one in which the power loss is zero. The switching elements may use field effect transistors, bi-polar transistors and the like.

As the transmitter using the binary class-D amplifier shown in FIG. 1, for example a binary transmitter combined with a ΔΣ (delta-sigma) modulator that converts baseband signals into binary signals has been known. In the binary transmitter, the digital baseband signal that has been converted into binary signal by ΔΣ modulation, is amplified to a desired level by the binary class-D amplifier shown in FIG. 1, then output to the antenna via a filter.

Further, examples of the switching amplifier may include a class-D amplifier that amplifies signals that have logical values with multiple numbers of bits (which will be referred to hereinbelow as multilevel class-D amplifier), so that multilevel transmitters including the multilevel class-D amplifier in combination with a multilevel ΔΣ modulator that converts the baseband signals into multilevel signals, have been also known.

FIG. 2 is a block diagram showing a configuration of a multilevel transmitter of the background art, equipped with multilevel ΔΣ modulators and a multilevel class-D amplifier.

The multilevel transmitter shown in FIG. 2 includes digital baseband circuit (Digital Baseband) 110, RF signal generator 120 including multilevel ΔΣ modulators, multilevel class-D amplifier 130 and filter 140.

RF signal generator 120 performs multilevel ΔΣ modulation on each of two orthogonal signals (I-signal and Q-signal) generated by digital baseband circuit 110 and upconverts the signals after multilevel ΔΣ modulation to the desired radio signal frequency and outputs the sum of the two signals after upconversion. The output signal from RF signal generator 120 is decoded by an unillustrated decoder, so that the decoded signal drives multiple switching elements (described later) included in multilevel class-D amplifier 130.

Multilevel class-D amplifier 130 includes a plurality of power supplies V₀ to V_{N} (N is an integer equal to or greater than 0) different in output voltage (d.c. voltage) and a switch group composed of a plurality of switching elements, each inserted between one of multiple power supplies V₁ to V_{N} and the output terminal and inserted between the output terminal and ground potential V₀. Multilevel class-D amplifier 130, based on the output signal from RF signal generator 120, turns ON one corresponding switching element to output the power supply voltage or ground potential to be supplied to the turned-ON switching element. The radio signal amplified by multilevel class-D amplifier 130 is output to the antenna via filter 140.

Since the multilevel transmitter shown in FIG. 2 can put logical values with multiple numbers of bits on the sending signal, this transmitter has the advantage of low quantized noise arising from the ΔΣ modulators and an improved signal-to-noise power ratio, compared to the binary transmitter including the binary class-D amplifier shown in FIG. 1. The configurational examples of the above binary transmitter and multilevel transmitter have also been proposed by Patent Documents 1 and 2, for example.

As described above, the multilevel transmitter shown in FIG. 2 is improved in signal-to-noise power ratio compared to the binary transmitter including the binary class-D amplifier shown in FIG. 1. However, since the multilevel transmitter needs a plurality of power supplies different in output voltage (d.c. voltage) for configuring the multilevel class-D amplifier, this entails a problem in which the cost of the entire apparatus increases. Therefore, this has given rise to the requirement that a transmitted be able to achieve an improved signal-to-noise power ratio without use of a multilevel class-D amplifier. Patent Documents 1 and 2 show techniques for improving the power efficiency of the class-D amplifier, but do not present any technique for improving the signal-to-noise power ratio of the transmitter.

### RELATED ART DOCUMENTS

### Patent Document

Patent Document 1: JP2011-077979A
Patent Document 2: WO 2001/078120

### SUMMARY

It is therefore an object of the present invention to provide a transmitter including a class-D amplifier that can achieve an improved signal-to-noise power ratio.

In order to achieve the above object, the transmitter according to an exemplary aspect of the present invention includes:

a plurality of digital transmitters which perform delta-sigma modulation on the same baseband signal;

a combiner that combines the output signals from the plural digital transmitters and outputs the combined result;

a control unit that generates an external signal different for every digital transmitter, to be supplied to each of the digital transmitters; and,

an input means that supplies the different external signal for every digital transmitter, to the input terminal or the internal node of a delta-sigma modulator that performs the delta-sigma modulation, the delta-sigma modulator being provided for every digital transmitter.

### BRIEF DESCRIPTION OF DRAWINGS

FIG. 1 is a circuit diagram showing a configurational example of a class-D amplifier as a representative example of a switching amplifier.

FIG. 2 is a block diagram showing a configuration of a background art multilevel transmitter including multilevel ΔΣ modulators and a multilevel class-D amplifier.

FIG. 3 is a block diagram showing one configurational example of a transmitter of the first exemplary embodiment.

FIG. 4 is a block diagram showing one configurational example of a ΔΣ modulator.

FIG. 5 is a circuit diagram showing other insert examples of the changeover switch shown in FIG. 3.

FIG. 6 is a block diagram showing another configurational example of a transmitter of the first exemplary embodiment.

FIG. 7 is a block diagram showing another configurational example of a transmitter of the first exemplary embodiment.

FIG. 8 is a circuit diagram showing another configurational example of a combiner that is applicable to the transmitter shown in FIG. 3.

FIG. 9 is a circuit diagram showing another configurational example of a combiner that is applicable to the transmitter shown in FIG. 3.

FIG. 10 is a block diagram showing one configurational example of a transmitter of the second exemplary embodiment.

FIG. 11 is a block diagram showing one configurational example of a transmitter of the third exemplary embodiment.

### EXEMPLARY EMBODIMENT

Next the present invention will be described with reference to the drawings.

### The First Exemplary Embodiment

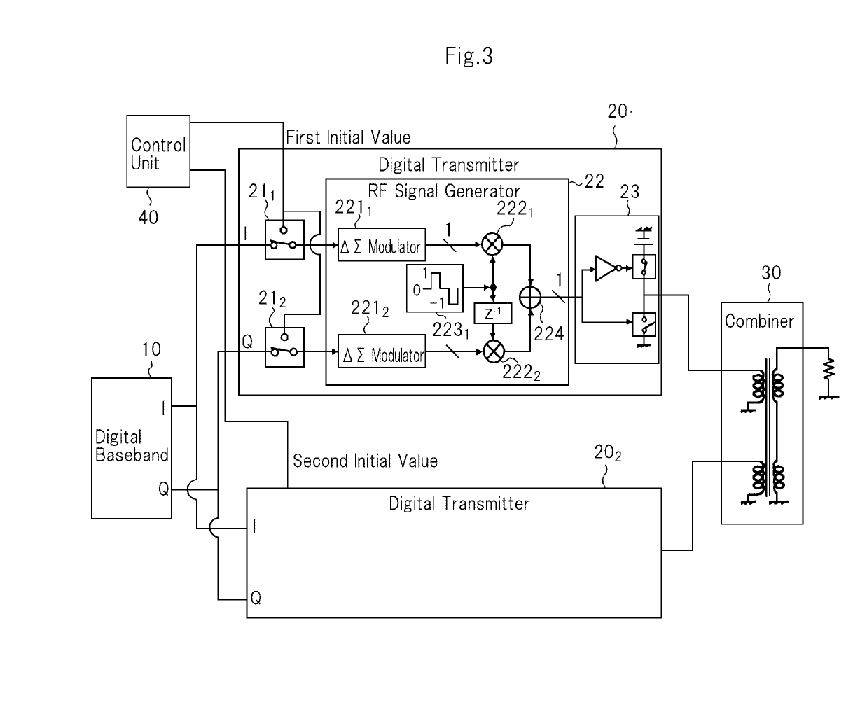

FIG. 3 is a block diagram showing one configurational example of a transmitter of the first exemplary embodiment.

The transmitter shown in FIG. 3 includes digital baseband circuit (Digital baseband) 10, two digital transmitters 20₁ and 20₂, combiner 30 and control unit 40.

Digital baseband circuit 10 modulates two signals orthogonal to each other in accordance with the transmit information as the signals to be transmitted, to produce and output two baseband signals (I-signal and Q-signal). The I-signal and Q-signal generated by digital baseband circuit 10 are input to digital transmitters 20₁ and 20₂. That is, digital transmitters 20₁ and 20₂ are supplied with the same I-signal and Q-signal.

Digital transmitters 20₁ and 20₂ each include changeover switches 21₁ and 21₂, RF signal generator 22 and class-D amplifier 23.

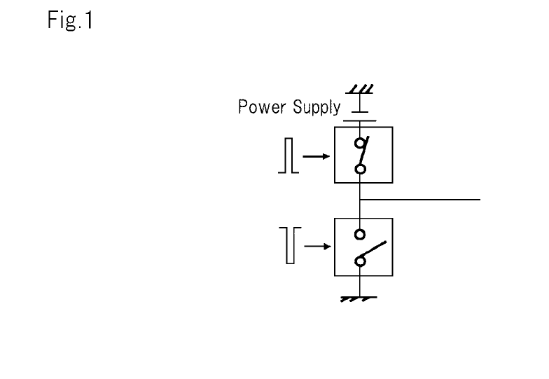

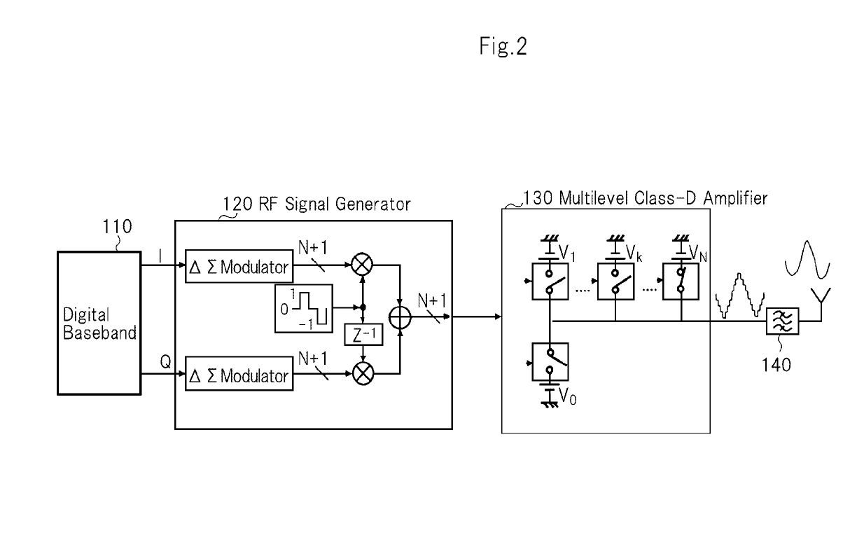

RF signal generator 22 included in digital transmitters 20₁ and 20₂ shown in FIG. 3 is equivalent to one in which the multilevel RF signal generator 120 shown in FIG. 2 is replaced by a configuration that outputs two levels (logic ‘1’ and ‘0’) while class-D amplifier 23 uses the binary class-D amplifier shown in FIG. 1.

Changeover switches 21₁ and 21₂ are used as input means that supplies the first initial value or the second initial value to the input terminal of an aftermentioned ΔΣ modulator, or the internal node of the ΔΣ modulator, that is included in RF signal generator 22.

The first initial value and the second initial value are generated by control unit 40 that is provided in the communication equipment including the transmitter and receiver of the present invention such as a mobile phone, radio LAN device and the like and controls the operation of the entire communication device, and that is supplied to digital transmitters 20₁ and 20₂. Control unit 40 can be realized by an information processing IC (micro computer) or the like that executes processes in accordance with a program, for example.

Changeover switch 21₁ is provided corresponding to the I-signal supplied from digital baseband circuit 10 to receive input of the first initial value supplied from the outside and the I-signal supplied from digital baseband circuit 10. Changeover switch 21₁ supplies the first initial value from the outside to RF signal generator 22 in the initial state of the transmitter and supplies the I-signal from digital baseband circuit 10 to RF signal generator 22 after the initial state, in accordance with the control signal input from control unit 40 or the like.

Changeover switch 21₂ is provided corresponding to the Q-signal supplied from digital baseband circuit 10 to receive input of the first initial value supplied from the outside and the

Q-signal supplied from digital baseband circuit 10. Changeover switch 21₂ supplies the first initial value from the outside to RF signal generator 22 in the initial state of the transmitter and supplies the Q-signal from digital baseband circuit 10 to RF signal generator 22 after the initial state, in accordance with the control signal input from control unit 40 or the like. The first initial value is a fixed value generated by and supplied from the aforementioned control unit 40, for example.

RF signal generator 22 includes two ΔΣ modulators 221₁ and 221₂ arranged for the I-signal and the Q-signal, respectively, two multipliers 222₁ and 222₂ arranged for the I-signal and the Q-signal, respectively, local signal generator 223, and adder 224.

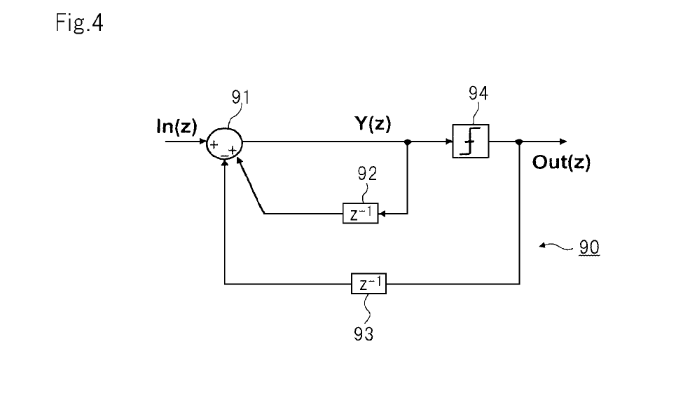

ΔΣ modulators 221₁ and 221₂ perform primary ΔΣ modulation on the input signals. ΔΣ modulators 221₁ and 221₂ for performing primary ΔΣ modulation can be realized by the configuration shown in FIG. 4, for example.

FIG. 4 is a block diagram showing one configurational example of the ΔΣ modulator.

ΔΣ modulator 90 shown in FIG. 4 includes adder 91, first delay unit 92, second delay unit 93 and comparator 94.

Input signal In(z) to ΔΣ modulator 90 shown in FIG. 4 is supplied to adder 91. Output signal Y(z) from adder 91 is delayed by first delay unit 92 and then positively fed back to adder 91. Also, output signal Y(z) from adder 91 is converted into binary signals by comparator 94 and is output as output signal Out(z). Output signal Out(z) is delayed by second delay unit 93, and then negatively fed back to adder 91.

In this configuration, the feedback loop composed of adder 91 and first delay unit 92 forms an integrator, so that the relational equation between input signal In(z) and output signal Out(z) holds as follows:

Out(z)=In(z)+(1−z)·N(z),

where N(z) represents quantized error.

Multipliers 222₁ and 222₂ provided for RF signal generator 22 shown in FIG. 3 are frequency converters that upconvert the signals output from ΔΣ modulators 221₁ and 221₂, into desired radio signal frequencies, using pulse train signals generated by local signal generator 223.

Adder 224 adds up the signals output from the two multipliers 222₁ and 222₂ and outputs the result.

The output signal from adder 224 is amplified by class-D amplifier 23 to the desired level and output.

Digital transmitter 20₂ shown in FIG. 3 has the same configuration as that of aforementioned digital transmitter 20₁, except in that the second initial value that is different from the first initial value is input to RF signal generator 22 in the initial state. Similarly to the first initial value, the second initial value is a fixed value generated and supplied by control unit 40.

Combiner 30 combines the output signals from two digital transmitters 20₁ and 20₂ and supplies the resultant signal to the load. As shown in FIG. 3, combiner 30 is embodied by a transformer having two primary windings to which the output signals from digital transmitters 20₁ and 20₂ are individually input and two secondary windings that are provided corresponding to the primary windings, connected in series. Output from combiner 30 shown in FIG. 3 is the sum of the output voltage from digital transmitter 20₁ and the output voltage from digital transmitter 20₂. The radio signal output from combiner 30 is output to the antenna via an unillustrated filter, for example.

In this configuration, since output signal Tx1(t) from digital transmitter 20₁ includes radio signal S(t) and quantized noise N1(t) arising at ΔΣ modulators 221₁ and 221₂, output signal Tx1(t) from digital transmitter 20₁ can be represented by the following equation (1):

Tx1(t)=S(t)+N1(t) (1)

As described above, in digital transmitter 20₁ the first initial value is input to ΔΣ modulators 221₁ and 221₂ in the initial state.

On the other hand, when radio signals are transmitted, the I-signal and Q-signal generated by digital baseband circuit 10 are input to ΔΣ modulators 221₁ and 221₂.

Here, quantized noise N1(t) on the right side of the above Eq. (1) depends on the first initial value as shown below.

For example, when ΔΣ modulator 90 shown in FIG. 4 is used for ΔΣ modulators 221₁ and 221₂, if the input signals to ΔΣ modulator 90 are In(0), In(1), In(2), . . . , n(n), Y(n), the output signal from adder 91 is represented by the following equation (101).

[Math 1]

Y(n)=Y(n−1)+In(n)−Out(n−1) (101)

Eq. (101) can be expanded as the following equation (102)

[Math 2]

Y(n)=Y(0)+Σₖ₌ₜⁿ{In(k)−Out(k−1)} (102)

The second term on the right side of the above Eq. (102) is the summation of the differences between the current input signal and the past output signal, expressing the operation of the integrator composed of adder 91 and first delay unit 92. That is, the output signal from adder 91 depends on the initial value, Y(0) of the output signal from adder 91. Further, when considering that Y(0), the initial value of the output signal from adder 91, is determined by addition and subtraction of In(0), the initial value of the input signal, Out(0), the initial value of the output signal and Y(−1), the past output signal of adder 91, it is known that Y(n), the output signal of adder 91, also depends on In(0), the initial value of the input signal, and Out(0), the initial value of the output signal.

Quantized noise N(n) arising at comparator 94 shown in FIG. 4 is the difference between Out(n), the output signal, and Y(n), the output signal of adder 91, and is represented by the following equation (103).

[Math 3]

N(0)=Out(n)−Y(0)+Σᵢ₌₁ⁿ{In(k)−Out(k−1)} (103)

It is understood from the above Eq. (103), quantized noise N(n) also depends onY(0), the initial value of the output signal from adder 91, or In(0), the initial value of the input signal, and Out(0), the initial value of the output signal.

Herein, signal-to-noise power ratio SNR1 of the output from digital transmitter 20₁ shown in FIG. 3 is expressed by the following equation (2) using the time square average of radio signal S(t) and the time square average of quantized noise N1(t).

[Math 4]

SNR1= S̅(̅t̅)̅²̅/ N̅1̅(̅t̅)̅²̅ (2)

Further, since Tx2(t), the output signal from digital transmitter 20₂ shown in FIG. 3, includes radio signal S(t) and quantized noise N2(t) arising at ΔΣ modulators 221₁ and 221₂, Tx2(t), the output signal from digital transmitter 20₂, can be expressed by the following equation (3).

Tx2(t)=S(t)+N2(t) (3)

In digital transmitter 20₂ the second initial value is input to ΔΣ modulators 221₁ and 221₂ in the initial state.

On the other hand, when radio signals are transmitted, the I-signal and Q-signal generated by digital baseband circuit 10 are input to ΔΣ modulators 221₁ and 221₂.

Herein, the signal-to-noise power ratio SNR2 in digital transmitter 20₂ is expressed by the following equation (4) using the time square average of radio signal S(t) and the time square average of quantized noise N1(t).

[Math 5]

SNR2= S̅²̅/ N̅2̅(̅t̅)̅²̅ (4)

In digital transmitters 20₁ and 20₂, the initial values of the input signals to ΔΣ modulators 221₁ and 221₂ are different from each other as described above. Accordingly, the quantized noises N1(z) and N2(z) given by the above equation (103) are not equal. On the other hand, because of the statistical nature of noise, the time square averages of quantized noises N1(z) and N2(z) become equal to each other. That is, the following equation (5) holds.

[Math 6]

N̅1̅(̅t̅)̅²̅/ N̅2̅(̅t̅)̅²̅ (5)

It is understood from this that even if the initial values of the input signals are different, the signal-to-noise power ratio in digital transmitter 20₁ and the signal-to-noise power ratio in digital transmitter 20₂ given by equations (2) and (4) are equal to each other.

Combiner 30 combines the output signal from digital transmitter 20₁ and the output signal from digital transmitter 20₂. Accordingly, Com1(1), the output from combiner 30, is equal to the sum of the right side of the above Eq. (1) and the right side of the above Eq. (3). That is,

Com1(1)=2S(t)+N1(t)+N2(t) (6)

holds.

On the other hand, SNRcom, the signal-to-noise power ratio in the output from combiner 30, is represented by the following Eq. (7).

[Math 7]

SNR_{com}=4· S̅(̅t̅)̅²̅/ (̅N̅1̅(̅t̅)̅+̅N̅2̅(̅t̅)̅)̅²̅ (̅N̅1̅(̅t̅)̅+̅N̅2̅(̅t̅)̅)̅²̅ (7)

In the denominator on the right side of Eq. (7), since quantized noises N1(t) and N2(t) are unequal to each other as described above, the time average of the product of quantized noises N1(t) and N2(t) becomes zero based on the statistic characters of noise. As a result, the denominator on the right side of Eq. (7) can be expanded as shown in the following equation (8)

[Math 8]

(̅N̅1̅(̅t̅)̅+̅N̅2̅(̅t̅)̅)̅²̅ (̅N̅1̅(̅t̅)̅+̅N̅2̅(̅t̅)̅)̅²̅= N̅1̅(̅t̅)̅²̅+ N̅2̅(̅t̅)̅²̅ (8)

From the above Eq. (8) and Eq. (5), Eq. (7) can be rewritten as the following Eq. (9).

[Math 9]

SNR_{com}=2· S̅(̅t̅)̅²̅/ N̅1̅(̅t̅)̅²̅ (9)

As understood from Eq. (9), SNRcom, the signal-to-noise power ratio in the output of combiner 30 is equal to the double of SNR1, the signal-to-noise power ratio in the output of digital transmitter 20₁ (=SNR2, the signal-to-noise power ratio in the output of digital transmitter 20₂).

This means that the configuration shown in FIG. 3 can improve the signal-to-noise power ratio compared to a configuration having only a single digital transmitter with no initial value provided.

Further, in the transmitter shown in FIG. 3, digital transmitters 20₁ and 20₂ have the same configuration and the power supply voltages that are to be used by class-D amplifier 24 in each are equal. Accordingly, it is possible to use a single common power supply voltage in class-D amplifiers 24.

As a result, without using multilevel class-D amplifier 130 that requires a plurality of power supplies as shown in FIG. 2, it is possible to provide a transmitter that can improve signal-to-noise power ratio. Further, it is possible to hold down the sampling frequency or the over sampling ratio of ΔΣ modulators 221₁ and 221₂ that is required to obtain the equivalent signal-to-noise power ratio, cut down the power consumption of the ΔΣ modulators, and hence reduce the power consumption of the transmitter as a whole.

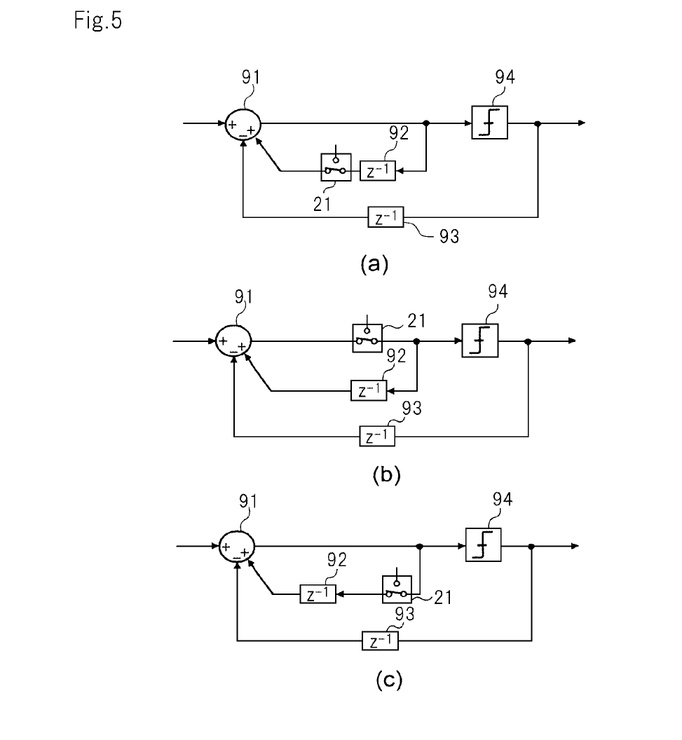

The node to which the initial value is supplied to RF signal generator 22 is not limited to the input terminals of ΔΣ modulators 221₁ and 221₂ as shown in FIG. 3, but the internal nodes of ΔΣ modulators 221₁ and 221₂ may be adopted. FIGS. 5(a) to 5(c) show configurational examples in which changeover switch 21 is inserted in the feedback loop of adder 91 and first delay unit 92 that forms an integrator in the primary ΔΣ modulator 90 shown in FIG. 4. Further, changeover switch 21 should be limited to the positions shown in FIGS. 5(a), 5(b) and 5(c), but may be inserted in other internal nodes of ΔΣ modulators 221₁ and 221₂. Moreover, in a well-known higher order ΔΣ modulator, changeover switches may be inserted inside the feedback loop that forms an integrator or at another internal node to supply the initial value. With such a configuration, it is also possible to have the same effect as the above configuration where the initial value is supplied to the input terminal of ΔΣ modulator 90.

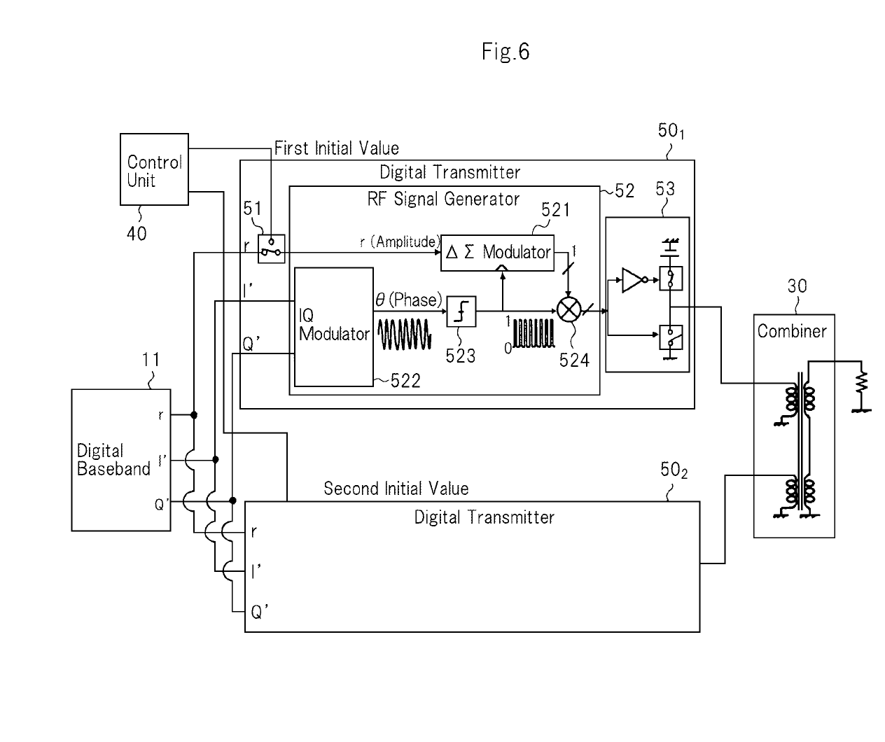

The RF signal generator provided in the digital transmitter of the present exemplary embodiment may be replaced by the configuration shown in FIG. 6. RF signal generator 52 shown in FIG. 6 is one that is described in FIG. 1(c) of Non-patent Document 1 (S. Hori, K. Kunihiro, K. Takahashi and M. Fukaishi, “A 0.7-3 GHz envelope delta-sigma modulator using phase modulated carrier clock for multi-mode/band switching amplifiers”, IEEE Radio Frequency Integrated Circuits Symposium Digest, pp. 35-38, June 2011).

FIG. 6 is a block diagram showing another configurational example of a transmitter of the first exemplary embodiment.

The transmitter shown in FIG. 6 includes digital baseband circuit 11, two digital transmitters 50₁ and 50₂, combiner 30 and control unit 40. The configuration and operation of combiner 30 is the same as in the transmitter shown in FIG. 3.

Digital baseband circuit 11 generates and outputs amplitude signal r which is the amplitude component of the baseband signal and phase orthogonal signals (I′-signal, Q′-signal) that are obtained by dividing two baseband signals (I-signal, Q-signal) that are orthogonal to each other by amplitude signal r. The amplitude signal r, I′-signal and Q′-signal generated by digital baseband circuit 11 are supplied to each of two digital transmitters 50₁ and 50₂.

Digital transmitters 50₁ and 50₂ each include changeover switch 51, RF signal generator 52 and class-D amplifier 53. The configuration and operation of changeover switch 51 is the same as that of changeover switch 21₁ (or 21₂) shown in FIG. 3. In the configuration shown in FIG. 6, in the initial state the first initial value is input to RF signal generator 52 of digital transmitter 50₁ while the second initial value is input to RF signal generator 52 of digital transmitter 50₂. Class-D amplifier 53 uses the binary class-D amplifier shown in FIG. 1, as in the digital transmitter 20₁ shown in FIG. 3.

RF signal generator 52 includes ΔΣ modulator 521 provided for amplitude signal r, IQ modulator (orthogonal modulator) 522 that converts I′-signal and Q′-signal into RF band phase signals, comparator 523 that converts the RF band phase signals output from IQ modulator 522 into rectangular pulse phase signals, and adder 524 that adds up the output signals from ΔΣ modulator 521 and comparator 523. ΔΣ modulator 521 performs ΔΣ modulation on amplitude signal r, using the pulse phase signal (RF band phase signal) output from comparator 523 as a clock signal. Multiplier 524 combines the output signal from ΔΣ modulator 521 and the RF band phase signal and outputs the result.

Digital transmitter 50₂ has the same configuration as that of digital transmitter 50₁ except that the second initial value that is different from the first initial value is input to RF signal generator 52 in the initial state. The first initial value and the second initial value are generated and supplied by control unit 40 similarly to the transmitter shown in FIG. 3.

Similarly to the transmitter shown in FIG. 3, also in the transmitter shown in FIG. 6 it is possible to provide a transmitter that can achieve an improved signal-to-noise power ratio without using a multilevel class-D amplifier that requires a plurality of power supplies. Further, it is possible to hold down the sampling frequency or the over sampling ratio of ΔΣ modulator 521 that is required to obtain the equivalent signal-to-noise power ratio, and therefore decrease power consumption of the ΔΣ modulator 521 and reduce power consumption of the transmitter as a whole.

Here, the configuration shown in the present exemplary embodiment may also be applied to a transmitter including an RF signal generator with a multilevel ΔΣ modulator, and a multilevel class-D amplifier.

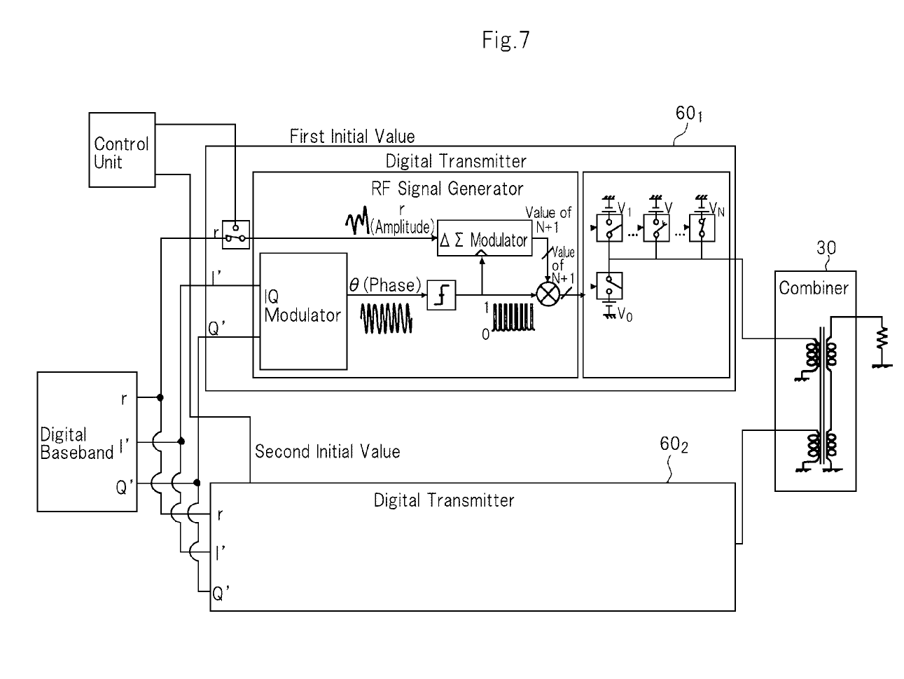

For example, in the transmitter shown in FIG. 6, RF signal generator 52 may be replaced by an RF signal generator with multilevel outputs while class-D amplifier 53 may be replaced by a multilevel class-D amplifier. FIG. 7 shows a configurational example of such a multilevel transmitter.

FIG. 7 is a block diagram showing another configurational example of a transmitter of the first exemplary embodiment.

The ΔΣ modulator included in the RF signal generator shown in FIG. 7 outputs the same number of values as that of the voltage values output by a multilevel class-D amplifier in the downstream stage. The output signal from the RF signal generator is decoded by a decoder that is not shown. The signal after decoding is amplified by a driver amplifier and then supplied to the multilevel class-D amplifier.

The multilevel class-D amplifier, similarly to that in the multilevel transmitter shown in FIG. 2, includes a plurality of power supplies V₀ to V_{N} (N is an integer equal to or greater than 0) different in output voltage (d.c. voltage) and a switch group of a plurality of switching elements, each inserted between any one of multiple power supplies V₁ to V_{N} and the output terminal and inserted between the output terminal and ground potential V₀, and amplifies the output signal from the RF signal generator to turn on and off the corresponding switching elements in accordance with the output signal from the driver amplifier.

Since, in the transmitter shown in FIG. 7, digital transmitters 60₁ and 60₂ each include multilevel class-D amplifier, the signal-to-noise power ratio is improved compared to the configurations that includes a binary class-D amplifier shown in FIGS. 3 and 6. That is, the transmitter shown in FIG. 7, in which different initial values are input to the multilevel ΔΣ modulators in two digital transmitters 60₁ and 60₂ in the initial state, combines the output signals from these two digital transmitters 60₁ and 60₂, so that it is possible to further improve the signal-to-noise power ratio compared to the binary transmitters shown in FIGS. 3 and 6.

Further, in the present exemplary embodiment, it is possible in the transmitter shown in FIG. 3 to replace RF signal generator 22 by multilevel output RF signal generator 120 shown in FIG. 2 and replace class-D amplifier 23 by multilevel class-D amplifier 130 shown in FIG. 2. The thus configured multilevel transmitter can also present the same effect as that of the transmitter FIG. 7.

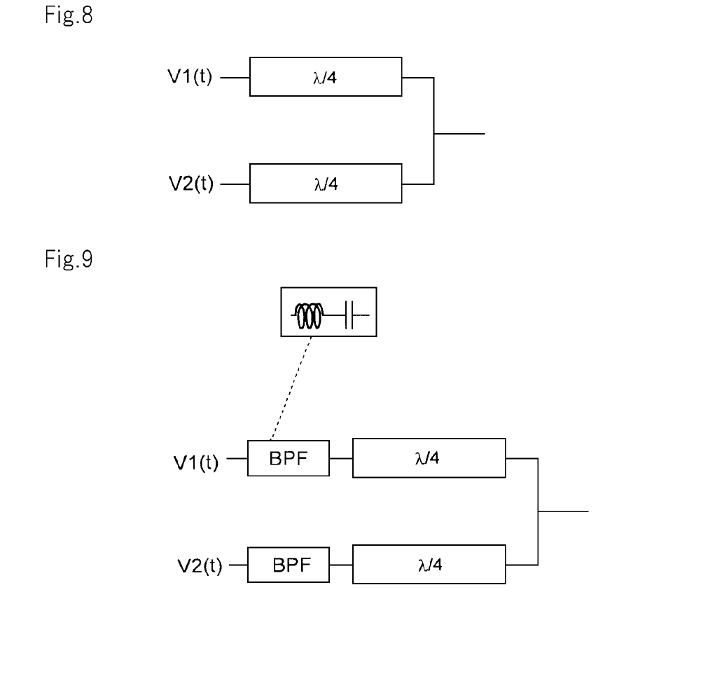

Combiners 30 shown in FIGS. 3, 6 and 7 may be realized by another circuit. FIGS. 8 and 9 show other configurational examples of combiner 30 that can be applied to the transmitters shown in FIGS. 3, 6 and 7.

The combiner shown in FIG. 8 is composed of a plurality of transmission lines each of which receives the output signal from a different digital transmitter at one ends while the other ends of the transmission lines are connected to each other. Each transmission line is formed to have a length of the quarter wavelength of the carrier frequency included in the ratio signal output from the digital transmitter. The transmission line having a length of the quarter wavelength of the carrier frequency will be referred to hereinbelow as “λ/4 transmission line”.

The λ/4 transmission line converts the input voltage signal V(t) to current signal I(t) represented by the following equation and outputs the current.

I(t)=V(t)/z₀ (10),

where z₀ is the characteristic impedance of the 2J4 transmission line.

In the combiner shown in FIG. 8, when V1(t) represents the voltage signal input to one of the λ/4 transmission lines and V2(t) represents the voltage signal input to the other λ/4 transmission line, the first λ/4 transmission line outputs current signal I1(t) and the other λ/4 transmission line outputs current signal I2(t). Herein, when the load connected to the output of the combiner shown in FIG. 8 is denoted by Rload, voltage Vload(t) applied to the load is written from the above Eq. (10) as the following equation (11).

Vload(t)=(V1(t)+V2(t))·Rload/z₀ (11).

Eq. (11) shows that a voltage proportional to the sum of signal voltages V1(t) and V2(t) input to the combiner shown in FIG. 8 is supplied to the load.

The combiner shown in FIG. 9 shows a configuration in which band bass filters that allow the desired radio signal band to pass therethrough are connected at the upstream stage of the combiner shown in FIG. 8.

The band pass filter may use inductor L and capacitor C connected in series as shown in FIG. 9, for example. Use of the combiner shown in FIG. 9 makes it possible to prevent noise other than the desired signal band being mixed into the transmission line. Here, when the combiner is realized by the transformer shown in FIG. 3 or 7, the band pass filter may be inserted between the combiner and each digital transmitter.

Combiner 30 is not limited to the configurations shown in FIGS. 3, 6, 8 and 9, but may use a well-known combiner such as a Wilkinson combiner or the like.

### The Second Exemplary Embodiment

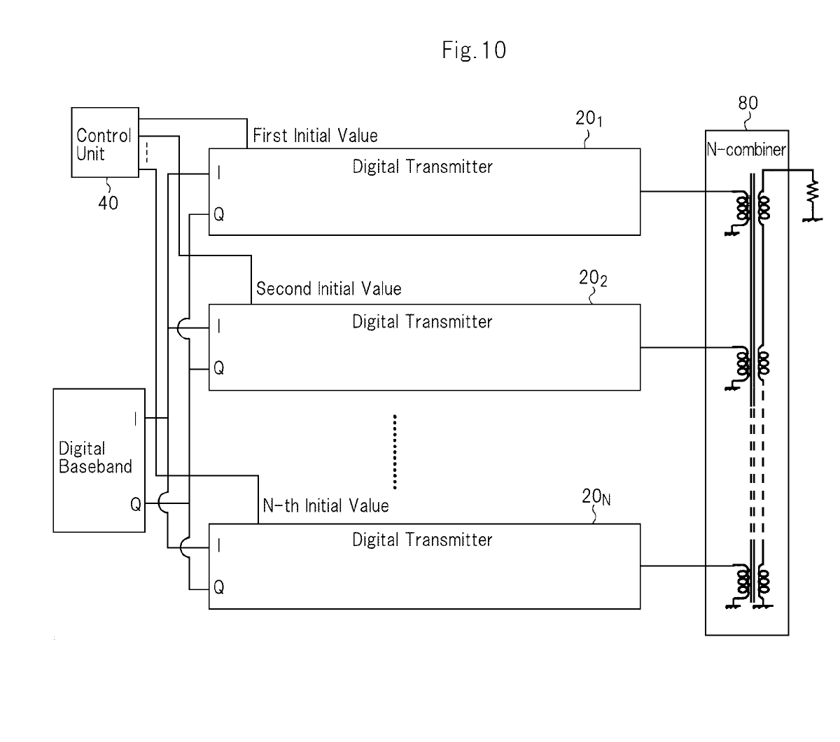

FIG. 10 is a block diagram showing one configurational example of a transmitter of the second exemplary embodiment.

The transmitter of the second exemplary embodiment includes N (N is an integer equal to or greater than 2) digital transmitters and is configured to combine the output signals from the individual digital transmitters through N-combiner 80 to output the combined result to the load.

The transmitter shown in FIG. 10 corresponds to the configuration shown in FIG. 3 in which the number of digital transmitters 20 is further increased. The configuration of each of digital transmitters 20₁ to 20_{N} is the same as the transmitter in the first exemplary embodiment. Input to N digital transmitters 20₁ to 20_{N} in the initial state are initial values (the first to N-th initial values) generated at control unit 40 to be different from each other.

N-combiner 80 may be realized, for example, by a transformer having N primary windings to which the output signals from digital transmitters 20₁ and 20_{N} are individually input and N secondary windings that are provided corresponding to the primary windings, connected in series.

When N digital transmitters 20₁ to 20_{N} provided for the transmitter shown in FIG. 10 are named k-th digital transmitters (k is an integer from 1 to N), output signal Tx_k(t) from the _k-th digital transmitter 20ₖ is represented by the following equation (12).

Tx_{—}k(t)=S(t)+N_{—}k(t) (12)

where N_k(t) is the quantized noise generated at the ΔΣ modulator arranged in the k-th digital transmitter 20ₖ.

N-combiner 80 combines the output signals from digital transmitters 20₁ to 20_{N} and outputs the combined result. The output voltage VNcom(t) from this N-combiner 80 is represented by the following equation (13).

VNcom(t)=N·S(t)+N_{—}1(t)+N_{—}2(t)+ . . . +N_{—}k(t) (13)

The signal-to-noise power ration SNR_{Ncom} of VNcom(t) in the output from N-combiner 80 is represented by the following equation (14)

[Math 10]

SNR_{Ncom}=N²· S̅(̅t̅)̅²̅/ (̅Σ̅ₖ̅₌̅₁̅^̅{̅N̅}̅N̅_̅{̅—̅}̅k̅(̅t̅)̅)̅²̅ (14)

Here, since the time average of the product of N_p(t) and N_q(t) (p and q are different integers) becomes zero based on the statistic characters of noise, the denominator on the right side of Eq. (14) can be expanded as Eq. (15).

[Math 11]

(̅Σ̅ₖ̅₌̅₁̅^̅{̅N̅}̅N̅_̅{̅—̅}̅k̅(̅t̅)̅)̅²̅=N· N̅_̅{̅—̅}̅1̅(̅t̅)̅²̅ (15)

Here, it is assumed that the time average of N_k(t)² is constant without depending on k.

From the above Eq. (15), Eq. (14) can be rewritten as the following equation (16).

[Math 12]

SNR_{Ncom}=N· S̅(̅t̅)̅²̅/ N̅ _̅{̅—̅}̅1̅(̅t̅)̅²̅ (16)

As described above, since the signal-to-noise power ratio in the output from the _k-th digital transmitter 20ₖ is represented by the aforementioned Eq. (2), Eq. (16) indicates that the signal-to-noise power ratio in the output from N-combiner 80 comes to N times of the signal-to-noise power ratio in the output of one digital transmitter.

That is, when the output signals from multiple digital transmitters each having a ΔΣ modulator that receives an initial value different from the others are combined, the desired signal power is amplified in proportion to the square of the number of combined signals, whereas the quantized noise arising at ΔΣ modulators is amplified in proportion to the number of combined signals. Accordingly, the signal-to-noise power ratio improves in proportion to the number of combined signals.

N digital transmitters 20₁ to 20_{N} all have the same configuration. The power supply voltage to be used for binary class-D amplifier of each of digital transmitters 20₁ to 20_{N} is also equal to that of the others. As a result, it is possible to use a single common power supply for the binary class-D amplifier of every digital transmitter.

Accordingly, similarly to the first exemplary embodiment, also in the transmitter shown in FIG. 10 it is possible to obtain a transmitter that can achieve an improved signal-to-noise power ratio without using a multilevel class-D amplifier that requires a plurality of power supplies. Further, it is possible to hold down the sampling frequency or the over sampling ratio of the ΔΣ modulators that is required to obtain the equivalent signal-to-noise power ratio, and therefore decrease power consumption of the ΔΣ modulators and reduce power consumption of the transmitter as a whole.

Here, N digital transmitters 20₁ to 20_{N} provided for the transmitter shown in FIG. 10 may be replaced by the configuration shown in FIG. 6 that includes binary output RF signal generator 52 and class-D amplifier 53.

Further, the configuration shown by this exemplary embodiment can also be applied to a transmitter that includes an RF signal generator with a multilevel ΔΣ modulator, and a multilevel class-D amplifier. For example, N digital transmitters 20₁ to 20_{N} provided for the transmitter shown in FIG. 10 may be replaced by the configuration shown in FIG. 7 that includes the multilevel output RF signal generator and multilevel class-D amplifier, or by the configuration that includes the multilevel output RF signal generator and multilevel class-D amplifier shown in FIG. 2.

Moreover, though FIG. 10 shows a configurational example in which the initial values are supplied to the input terminals of the ΔΣ modulators, the initial values may be supplied to the internal nodes of the ΔΣ modulators. In this case, as shown in FIGS. 5(a) to 5(c), a changeover switch may be inserted in the feedback loop forming an integrator in the ΔΣ modulator to thereby input the initial value, or a change over switch may be inserted in other internal nodes of ΔΣ modulators to input initial values.

Further, N-combiner 80 may be realized by the configuration that includes the λ/4 transmission lines shown in FIG. 8 or that includes the band pass filters and λ/4 transmission lines shown in FIG. 9. In this case, a λ/4 transmission line and a band pass filter may and should be disposed for every output from N digital transmitters 20₁ to 20_{N}. Moreover, N-combiner 80 may be realized by connecting well-known combiners in a cascade manner as in a Wilkinson combiner or the like.

### The Third Exemplary Embodiment

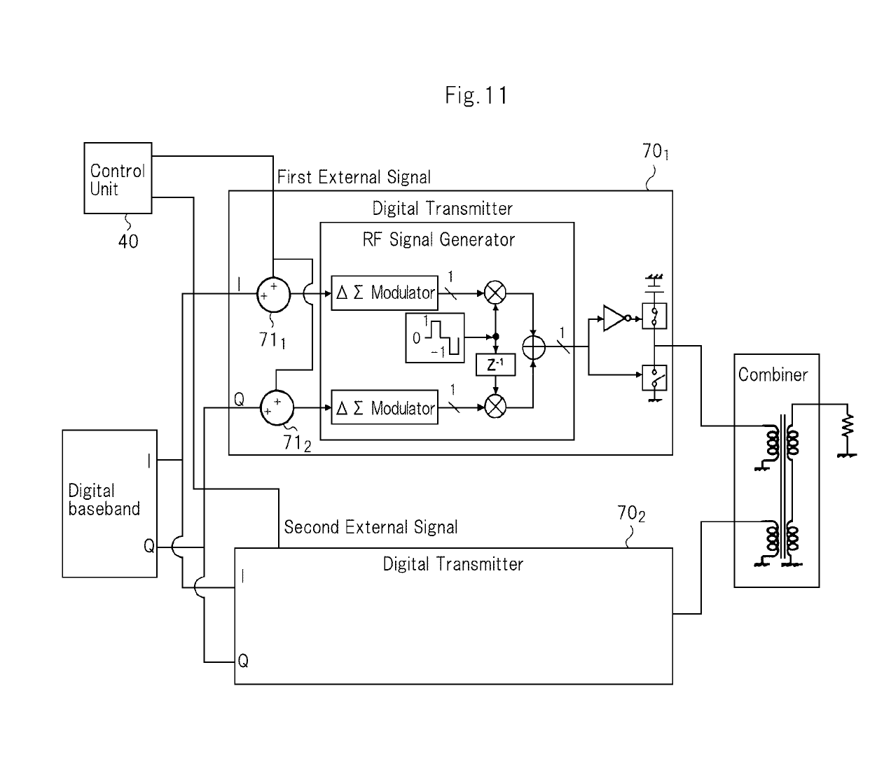

FIG. 11 is a block diagram showing one configurational example of a transmitter of the third exemplary embodiment.

The transmitter of the third exemplary embodiment is configured such that in the transmitter shown in FIG. 3, changeover switches 21₁ and 21₂ are replaced by adders 71₁ and 71₂ so that, instead of the fixed initial values, the first external signal and second external signal generated outside are supplied to the RF signal generator via adders 71₁ and 71₂. That is, in the present exemplary embodiment, adders 71₁ and 71₂ are used as the input terminals to the ΔΣ modulators in the RF signal generator or the input means for supplying external signals to the internal nodes of the ΔΣ modulators. The first external signal to be input to digital transmitter 70₁ and the second external signal to be input to digital transmitter 70₁ should be different from each other. The first external signal and the second external signal are generated and supplied by, for example control unit 40, similar to the first and second exemplary embodiment.

In the transmitter shown in FIG. 11, output signal Tx11(t) from digital transmitter 70₁ contains radio signal S(t), quantized noise N11(t) that arises at ΔΣ modulators and signal Ex11(t) supplied from the outside. Accordingly, output signal Tx11(t) from the digital transmitter can be represented by the following equation (17).

Tx11(t)=S(t)+Ex11(t)+N11(t) (17)

Similarly, output signal Tx12(t) from digital transmitter 70₂ contains radio signal S(t), quantized noise N12(t) that arises at ΔΣ modulators and signal Ex12(t) supplied from the outside. Accordingly, output signal Tx12(t) from digital transmitter 70₂ can be represented by the following equation (18).

Tx12(t)=S(t)+Ex12(t)+N12(t) (18)

Signal-to-noise power ratio SNR11 in the output from digital transmitter 70₁ can be represented by the following equation (19) when Ex11(t) is negligible relative to S(t) or when the condition that the signal bands of the two are far enough apart holds.

[Math 13]

SNR11= S̅(̅t̅)̅²̅/ N̅1̅1̅(̅t̅)̅²̅ (19)

Similarly, signal-to-noise power ratio SNR12 in the output from digital transmitter 70₂ can be represented by the following equation (20).

[Math 14]

SNR12= S̅(̅t̅)̅²̅/ N̅1̅2̅(̅t̅)̅²̅ (20)

Here, as shown in the above Eq. (103), the quantized noise arising at a ΔΣ modulator depends on the input signal to the ΔΣ modulator. Further, because a different external signal is supplied to each of the ΔΣ modulators, N11(t) and N12(t) are not equal.

When Com11(t) represents the output from the combiner and SNRcomll represents the signal-to-noise power ratio in the output from the combiner, the above equations (5) to (9) with N1(t), N2(t), Com(t) and SNRcom(t) replaced by N11(t), N12(t), Com11(t) and SNR11com(t) also hold.

That is, the following equation (21) holds in place of Eq. (9)

[Math 15]

SNR_{com}11=2· S̅(̅t̅)̅²̅/ N̅1̅1̅(̅t̅)̅²̅ (21)

As understood from Eq. (21), signal-to-noise power ratio SNRcom11 in the output from the combiner doubles signal-to-noise power ratio SNR11 in the output from digital transmitter 70₁ (=signal-to-noise power ratio SNR12 in the output from digital transmitter 70₂).

That is, compared to the configuration that includes only a single digital transmitter and that is supplied with no external signal, the signal-to-noise power ratio is improved in the transmitter shown in FIG. 11.

Further, digital transmitters 70₁ and 70₂ shown in FIG. 11 have the same configuration, and the binary class-D amplifiers of these digital transmitters use the same power supply voltage. Accordingly, it is possible to use a single common power supply voltage for the binary class-D amplifiers.

As a result, also in the transmitter shown in FIG. 11, similarly to the first exemplary embodiment it is possible to obtain a transmitter that can achieve an improved signal-to-noise power ratio without using a multilevel class-D amplifier that requires a plurality of power supplies. Further, it is possible to hold down the sampling frequency or the over sampling ratio of the ΔΣ modulators that is required to obtain the equivalent signal-to-noise power ratio, and therefore decrease power consumption of the ΔΣ modulators and reduce power consumption of the transmitter as a whole.

Here, in this case when a signal takes a significant value in the initial stage and then becomes zero (0) after the initial stage has been supplied as an external signal, the external signal will assume that the signal, which took a significant value at the initial stage, is a signal that can only offer an initial value to the ΔΣ modulator. In this case, the configuration shown in FIG. 11 is substantially equivalent to the first exemplary embodiment.

Digital transmitters 70₁ and 70₂ included in the transmitter shown in FIG. 11 may be replaced by a configuration that includes binary output RF signal generator 52 and class-D amplifier 53 shown in FIG. 6.

Further, the configuration shown by this exemplary embodiment can also be applied to a transmitter that includes an RF signal generator with a multilevel ΔΣ modulator, and a multilevel class-D amplifier. For example, digital transmitters 70₁ and 70₂ provided for the transmitter shown in FIG. 11 may be replaced by the configuration shown in FIG. 7 that includes the multilevel output RF signal generator and multilevel class-D amplifier, or by the configuration that includes the multilevel output RF signal generator and multilevel class-D amplifier shown in FIG. 2. Also in this case, the changeover switches need to be replaced with adders and, instead of initial values, external signals need to be supplied to ΔΣ modulators of RF signal generators.

Further, as in the transmitter shown in FIG. 10, digital transmitter 70₁ of the transmitter shown in FIG. 11 that prepares N, may be arranged so that the output signals from these N digital transmitters may be combined by N-combiner 80.

Moreover, though FIG. 11 shows a configurational example in which the external signals are supplied to the input terminals of the ΔΣ modulators, the external signals may be supplied to the internal nodes of the ΔΣ modulators. In this case, as shown in FIGS. 5(a) to 5(c), the external signals may be input by inserting adder 71 to the feedback loop that forms an integrator in the ΔΣ modulator, or by inserting adder 71 in the other internal nodes of ΔΣ modulators.

Further, N-combiner 30 may be realized by the configuration that includes λ/4 transmission lines shown in FIG. 8 or that includes band pass filters and λ/4 transmission lines shown in FIG. 9, or may be realized with well-known combiners as in a Wilkinson combiner or the like.

Although the present invention has been explained with reference to the exemplary embodiments, the present invention should not be limited to the above exemplary embodiments. Various modifications that can be understood by those skilled in the art may be made to the structures and details of the present invention within the scope of the present invention.

This application is based upon and claims the benefit of priority from Japanese patent application No. 2012-20259, filed on Sep. 14, 2012, the disclosure of which is incorporated herein in its entirety by reference.

1. A transmitter comprising:
a plurality of digital transmitters which perform delta-sigma modulation on the same baseband signal;
a combiner that combines the output signals from the plural digital transmitters and outputs the combined result;
a control unit that generates an external signal different for every digital transmitter, to be supplied to each of the digital transmitters; and
an input means that supplies the different external signal for every digital transmitter, to the input terminal or the internal node of a delta-sigma modulator that performs the delta-sigma modulation, the delta-sigma modulator being provided for every digital transmitter.

2. The transmitter according to claim 1, wherein the external signal takes a significant value in the initial state of the digital transmitter and becomes zero after the initial state.

3. The transmitter according to claim 1 or 2, wherein the digital transmitter includes a binary class-D amplifier comprising:
a power supply that outputs d.c. voltage; and
switching elements interposed between the power supply and an output terminal and between the output terminal and the ground potential.

4. The transmitter according to claim 1, wherein the digital transmitter includes a binary class-D amplifier comprising:
a plurality of power supplies in which the output d.c. voltage of each power supply differs from the other power supply; and
a plurality of switching elements interposed between the plural power supplies and an output terminal and between the output terminal and the ground potential.

5. The transmitter according to claim 1, wherein the digital transmitter includes:
a delta-sigma modulator that receives input of an amplitude signal extracted from two orthogonal signals as the baseband signals and a phase signal extracted from the orthogonal signals and performs delta-sigma modulation on the amplitude signal, using the phase signal as the clock signal; and
a multiplier that multiplies the output signal from the delta-sigma modulator and the phase signal.

6. The transmitter according to a claim 1, wherein the digital transmitter includes:
two delta-sigma modulators that receive two orthogonal signals as the baseband signals and perform delta-sigma modulation on the two orthogonal signals;
frequency converters that upconvert the output signals from the two delta-sigma modulators to the desired radio signal frequency; and,
an adder that adds up the output signals from the frequency converters.

7. The transmitter according to claim 1, wherein the combiner includes a transformer in which a plurality of primary windings, to which the output signal for every digital transmitter is input, and a plurality of secondary windings arranged corresponding to the primary windings are connected in series.

8. The transmitter according to claim 1, wherein the combiner includes a plurality of transmission lines each of which receives the output signal from a different digital transmitter at one end while the other ends of transmission lines are connected to each other.

9. The transmitter according to claim 8, wherein the transmission line is formed with a length of one quarter wavelength of the carrier frequency contained in the radio signal.

10. The transmitter according to claim 1, wherein the combiner includes a band-pass filter that permits a desired radio signal to pass therethrough.
